(19) United States
(12) Patent Application Publication
(10) Pub. No.: US 2024/0160134 A1
(43) Pub. Date: May 16, 2024

(54) IMAGE FORMING APPARATUS

(71) Applicant: CANON KABUSHIKI KAISHA, Tokyo (JP)

(72) Inventor: NAOKA OMURA, Chiba (JP)

(21) Appl. No.: 18/505,896

(22) Filed: Nov. 9, 2023

(30) Foreign Application Priority Data
Nov. 10, 2022 (JP) 2022-180454

(51) Int. Cl. G03G 15/20; G03G 15/00

(52) U.S. Cl. CPC G03G 15/2053; G03G 15/2028; G03G 15/5008; G03G 2215/00523

(57) ABSTRACT

An image forming apparatus includes heating and pressing rotary members, an acquisition unit, and a speed control unit. In a print job where a first recording material is a first sheet and a second sheet, the acquisition unit acquires first information on the recording materials of the first and second sheets. The speed control unit controls a conveyance speed of the recording material of the first sheet based on the first information on the recording materials. In a print job where the first recording material is the first sheet and a second recording material is a third sheet, the acquisition unit acquires second information on the recording materials of the first and third sheets. The speed control unit controls the conveyance speed of the recording material of the first sheet based on the information on the recording material of the first sheet contained in the second information.

### BACKGROUND

### Field

The present disclosure relates to an image forming apparatus for forming a toner image on a recording material.

### Description of the Related Art

Image forming apparatuses include a fixing device that fixes an unfixed toner image on a recording material to the recording material.

A fixing device discussed in Japanese Patent Application Laid-Open No. 2005-321478 has been known as a device including a heating rotary member having a heat source for heating an unfixed toner image and a pressing rotary member for pressing the heating rotary member. Further, the fixing device includes a contact and separation mechanism, and the contact and separation mechanism moves the pressing rotary member to a position where the pressing rotary member is in contact with the heating rotary member and a position where the pressing rotary member is separated from the heating rotary member. When the pressing rotary member is in contact with the heating rotary member, a nip portion is formed between the heating rotary member and the pressing rotary member. When a recording material bearing an unfixed toner image is conveyed to the nip portion, heat and pressure for fixing the unfixed toner image are applied to the recording material in the nip portion, and the toner is fixed on the recording material.

In toner image forming on a recording material, the amount of heat for fixing a toner image varies by recording material types. Thus, the temperature of the heating rotary member is changed in accordance with a recording material type. In this way, the amount of heat to be applied to a toner image on a recording material is appropriately controlled.

Changing the amount of heat to an appropriate amount of heat in accordance with a recording material type improves image quality of a toner image formed on a recording material. On the other hand, if the temperature is changed for each recording material, the productivity is reduced. The fixing device discussed in Japanese Patent Application Laid-Open No. 2005-321478 has an image quality priority mode and a productivity priority mode. Thus, a user is able to select a mode to be used for fixing in accordance with the purpose of use.

Further, in the productivity priority mode, in a case of printing of a mixed job in which different types of recording materials are mixed, information on the types of the recording materials to be used in the printing is acquired for a predetermined number of sheets before processing of the printing is started. Japanese Patent Application Laid-Open No. 2005-321478 further discusses the configuration in which selection of a temperature is performed such that temperature change time to change the temperature for fixing a toner image on a different type of recording material is minimized, which results in further improvement in the productivity.

Further, in a case of a recording material having a large grammage, because the amount of heat for fixing a toner image is large, it is necessary to lower a conveyance speed of the recording material. Consequently, in a case of printing of a mixed job in which a recording material having a large grammage and a recording material having a small grammage are mixed, time is consumed to change the conveyance speed, which lowers the productivity. In order to address this issue, Japanese Patent Application Laid-Open No. 2005-321478 further discusses the configuration in which, in printing of a mixed job, the conveyance speed is reduced even for a recording material having a small grammage to save time for changing the conveyance speed.

In printing on a recording material having an uneven surface, such as an embossed sheet, various adjustments including changing a speed of a secondary transfer roller are performed. In a case of printing of a job in which a sheet requiring such an adjustment (adjustment required sheet), such as an embossed sheet, and a recording material other than the adjustment required sheet are mixed, if a recording material conveyance speed for the adjustment required sheet is set to a low speed, time is consumed for adjustments before conveyance of the adjustment required sheet. Consequently, the productivity of the entire job is decreased.

### SUMMARY

An image forming apparatus according to the present disclosure is directed to suppressing a productivity decrease that occurs in printing of a job in which an adjustment required sheet and a sheet other than the adjustment required sheet are mixed.

According to an aspect of the present disclosure, an image forming apparatus includes a heating rotary member configured to apply heat to a recording material, a pressing rotary member configured to be in contact with the heating rotary member to form a nip portion and, together with the heating rotary member, the pressing rotary member is configured to fix a toner image formed on the recording material, an acquisition unit configured to acquire information about the recording material before image formation is started, and a speed control unit configured to control a conveyance speed of the recording material at the nip portion, based on the information acquired by the acquisition unit, wherein, in a print job in which a first recording material is a first sheet and the first recording material is a second sheet, the acquisition unit acquires information on the recording materials of the first sheet and the second sheet, and the speed control unit controls a conveyance speed of the recording material of the first sheet, based on the information on the first sheet and the second sheet, and wherein, in a print job in which the first recording material is the first sheet and a second recording material is a third sheet, the acquisition unit acquires information on the first sheet and the third sheet, and the speed control unit controls the conveyance speed of the recording material of the first sheet, based on the information on the first sheet contained in the information on the first sheet and the third sheet.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an image processing system according to a present exemplary embodiment.

FIG. 2 is a diagram illustrating a configuration of a system according to the present exemplary embodiment.

FIG. 3 is a schematic diagram illustrating a configuration of an image forming apparatus according to the present exemplary embodiment.

FIG. 4 is a cross-sectional view of a fixing device according to the present exemplary embodiment.

FIGS. 5A to 5C are diagrams illustrating screens displayed in a mode setting.

FIG. 6 is a diagram illustrating a screen for an embossed depth setting.

FIGS. 7A to 7E are tables illustrating relationships between grammages, conveyance speeds, and fixing temperatures in respective temperature adjustment mode.

FIG. 8 is a flowchart illustrating an image forming process according to the present exemplary embodiment.

FIG. 9 is a flowchart illustrating an operation in a mixed sheet productivity priority mode.

FIG. 10 is a flowchart illustrating a processing procedure for setting a speed and temperature adjustment mode for a first sheet.

FIG. 11 is a flowchart illustrating a processing procedure for acquiring print plan information.

FIG. 12 is a flowchart illustrating a processing procedure for determining the speed and temperature adjustment mode.

FIG. 13 is a flowchart illustrating a processing procedure for setting the speed and temperature adjustment mode for a second and subsequent sheets.

FIG. 14 is a diagram illustrating a temperature adjustment mode selection example in a case of printing of a mixed job with an embossed depth being set to SHALLOW in the present exemplary embodiment.

FIG. 15 is a diagram illustrating a temperature adjustment mode selection example in a case of printing of a mixed job with an embossed depth being set to DEEP in the present exemplary embodiment.

FIG. 16 is a diagram illustrating a screen for setting the number of pages, print plan information on which is to be acquired.

### DESCRIPTION OF THE EMBODIMENTS

### <Image Processing System>

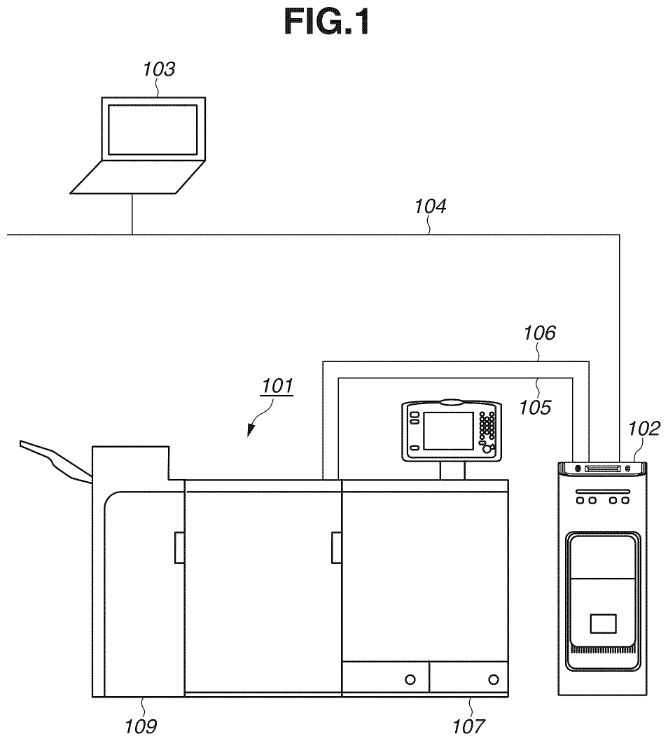

FIG. 1 is a diagram illustrating a configuration of an image processing system including an image forming apparatus 101 according to a first exemplary embodiment. The image processing system includes the image forming apparatus 101 and an external controller 102. Examples of the image forming apparatus 101 include a multifunction peripheral (MFP).

Examples of the external controller 102 include an image processing controller, a digital front end (DFE), and a print server.

The image forming apparatus 101 and the external controller 102 are connected to each other via an internal local area network (LAN) 105 and a video cable 106 to communicate with each other. The external controller 102 is connected to a client personal computer (PC) 103 via an external LAN 104. The external controller 102 acquires a print instruction (print job) from the client PC 103.

The client PC 103 is installed with a printer driver having a function of converting image data into a print description language processable by the external controller 102. A user issues a printing instruction via the printer driver by using various applications.

The printer driver transmits image data to the external controller 102, based on a print job issued by the user. The external controller 102 receives the print job containing image data from the client PC 103, performs a data analysis and a rasterizing process, and instructs the image forming apparatus 101 to perform printing (image forming) based on the image data.

The image forming apparatus 101 is configured with a plurality of apparatuses, which are connected to each and have different functions, including a printing apparatus 107 and is able to perform complicated printing processes, such as bookbinding. The image forming apparatus 101 according to the present exemplary embodiment includes the printing apparatus 107 and a finisher 109. The printing apparatus 107 forms an image using a developer (for example, toner) on a recording material (sheet) fed from a sheet feeding unit disposed in a lower part of a main body of the image forming apparatus 101. The printing apparatus 107 forms images in respective colors of yellow (Y), magenta (M), cyan (C), and black (K). A full-color image in which the images of the colors are superimposed on each other is formed on the recording material. The recording material on which the image has been formed is conveyed from the printing apparatus 107 to the finisher 109. The finisher 109 stacks recording materials on which images have been formed.

While this image processing system has the configuration in which the external controller 102 is connected to the image forming apparatus 101, the external controller 102 is not necessarily required. For example, the image forming apparatus 101 may directly acquire a print job containing image data from the client PC 103 via the external LAN 104. In this case, the image forming apparatus 101 performs a data analysis and a rasterizing process which are described above as being performed by the external controller 102. That is, the image forming apparatus 101 and the external controller 102 may be integrally configured.

### <System Configuration>

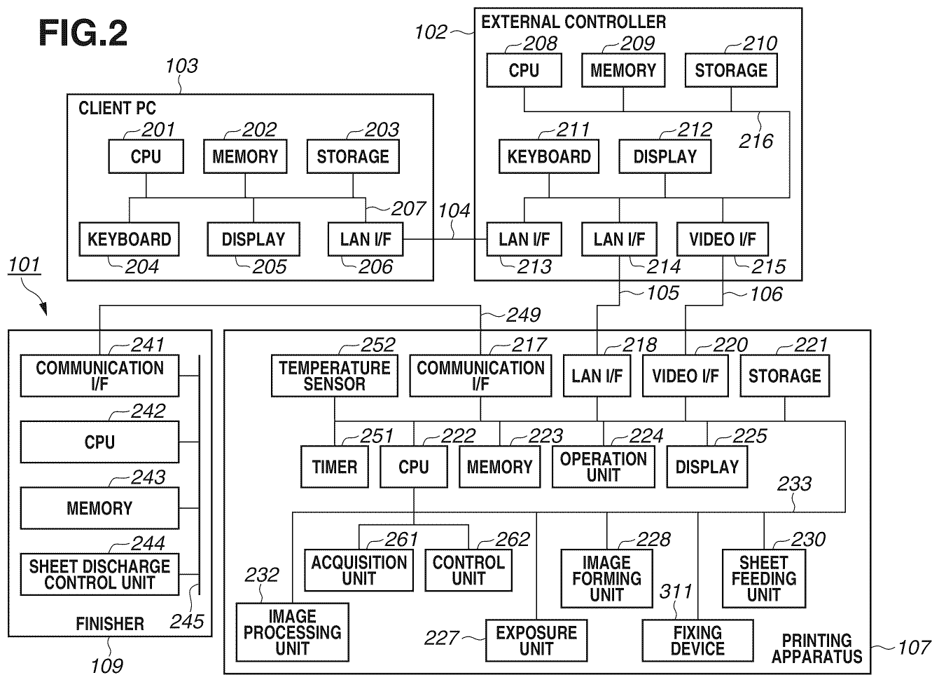

FIG. 2 is a diagram illustrating a configuration of a system that controls operations of the image processing system. Controllers for controlling operations of the image forming apparatus 101, the external controller 102, and the client PC 103 will be described.

### <Printing Apparatus>

The printing apparatus 107 includes a communication interface (UF) 217, a LAN OF 218, and a video OF 220 to communicate with other apparatuses. The printing apparatus 107 includes a central processing unit (CPU) 222, a memory 223, a storage 221, and an image processing unit 232 to control operations of the printing apparatus 107. The printing apparatus 107 includes an exposure unit 227, an image forming unit 228, a fixing device 311, and a sheet feeding unit 230 to form an image. The printing apparatus 107 includes an operation unit 224 and a display 225 as user interfaces. The printing apparatus 107 includes a timer 251 and a temperature sensor 252 to adjust a correction value to be used for appropriate correction of geometric characteristics of images to be printed on the front and back surfaces of a recording material.

Examples of the geometric characteristics of an image are, for example, the squareness of the image to a recording material, a printing position of the image with respect to the recording material, and the like. The above described components are connected to each other via a system bus 233 to communicate with each other.

The CPU 222 includes a control unit 262 and an acquisition unit 261. The control unit 262 includes a speed control unit for controlling a conveyance speed of a recording material and a temperature control unit for controlling a fixing temperature.

The communication OF 217 is connected to the finisher 109 via a communication cable 249 and controls communication between the printing apparatus 107 and the finisher 109. In a case where the printing apparatus 107 and the finisher 109 operate in cooperation with each other, information and data are transmitted and received via the communication OF 217. The LAN OF 218 is connected to the external controller 102 via the internal LAN 105 and controls communication with the external controller 102. The printing apparatus 107 receives a print setting from the external controller 102 via the LAN OF 218. The video OF 220 is connected to the external controller 102 via the video cable 106 and controls communication between the printing apparatus 107 and the external controller 102. The printing apparatus 107 receives image data of an image to be formed, from the external controller 102 via the video OF 220.

The CPU 222 comprehensively controls image processing and printing by executing a computer program stored in the storage 221. The memory 223 provides a work area where the CPU 222 executes various processes. In a case where an image forming process is performed, the CPU 222 controls the exposure unit 227, the image forming unit 228, the fixing device 311, and the sheet feeding unit 230.

The exposure unit 227 includes a photosensitive member, a charging wire that charges the photosensitive member, and a light source that exposes the photosensitive member charged with the charging wire to form an electrostatic latent image on the photosensitive member. The photosensitive member is, for example, a photosensitive belt having a photosensitive layer formed on a surface of a belt-shaped elastic member or a photosensitive drum having a photosensitive layer formed on a surface of a cylinder. Instead of the charging wire, a charging roller may be used. The exposure unit 227 charges a surface of the photosensitive member to a uniform negative potential with the charging wire. The exposure unit 227 outputs laser light based on image data from the light source. The laser light scans the uniformly charged surface of the photosensitive member. As a result, the potential of the photosensitive member at the position irradiated with the laser light changes, and an electrostatic latent image is formed on the surface of the photosensitive member. Four photosensitive members are disposed to correspond to four colors of yellow (Y), magenta (M), cyan (C), and black (K). On the four photosensitive members, electrostatic latent images corresponding to images of the respective colors are formed.

The image forming unit 228 transfers toner images formed on the photosensitive members onto a recording material. The image forming unit 228 includes developing devices, a transfer unit, and toner supply units. The developing devices each form a toner image by attaching negatively charged toner from a developing cylinder to an electrostatic latent image formed on the corresponding photosensitive member.

The developing devices are four devices corresponding to the respective four colors of yellow (Y), magenta (M), cyan (C), and black (K). The developing devices each develop an electrostatic latent image on the photosensitive member with toner of the corresponding color.

The transfer unit includes an intermediate transfer belt 308 and transfers the toner images from the photosensitive members to the intermediate transfer belt 308. Each primary transfer roller is disposed at a position opposite to the corresponding photosensitive member across the intermediate transfer belt 308. Application of a positive potential to the primary transfer rollers causes the toner images to be transferred from the four photosensitive members to the intermediate transfer belt 308 in a superimposed manner. In this way, a full-color toner image is formed on the intermediate transfer belt 308. The toner image formed on the intermediate transfer belt 308 is transferred to a recording material by a secondary transfer roller described below. Application of a positive potential causes the secondary transfer roller to transfer the full-color toner image from the intermediate transfer belt 308 to the recording material.

At a position upstream from a secondary transfer portion in the intermediate transfer belt 308, a backup member 318 is disposed in the proximity of a secondary transfer inner roller, and a leading end portion of the backup member 318 and an inner surface of the intermediate transfer belt 308 are in contact with each other. The position of the backup member 318 is changeable, which allows control of the static position of the backup member 318 and/or a shape of the intermediate transfer belt 308 of a portion upstream from the secondary transfer portion.

The fixing device 311 fixes the transferred toner image to the recording material. The fixing device 311 includes a heater and a pair of rollers. The fixing device 311 heats and pressurizes the toner image on the recording material with the heater and the pair of rollers to melt and fix the toner image to the recording material. As a result, a product in which an image is formed on the recording material is produced. The sheet feeding unit 230 includes conveyance rollers and various sensors in a conveyance path, and controls a feeding operation of the recording material.

The operation unit 224 is an input device that receives input of various settings and operation instructions from the user. Examples of the operation unit 224 include various input keys and a touch panel. The display 225 is an output device that displays setting information of the image forming apparatus 101 and a processing status (status information) of a print job.

The timer 251 counts time. The CPU 222 acquires the current date and time from a count value of the timer 251. The temperature sensor 252 measures the internal temperature of the printing apparatus 107. The CPU 222 acquires the internal temperature, which is one of environmental conditions, from a measurement result of the temperature sensor 252. As the environmental conditions, humidity may be acquired in addition to the temperature.

### <Finisher>

The finisher 109 executes, for example, staple processing on a product output from the printing apparatus 107. The finisher 109 includes a communication I/F 241, a CPU 242, a memory 243, and a sheet discharge control unit 244. These components are connected to each other via a system bus 245 to communicate with each other. The communication I/F 241 is connected to the printing apparatus 107 via the communication cable 249 and controls communication with the printing apparatus 107. In a case where the finisher 109 and the printing apparatus 107 operate in cooperation with each other, information and data are transmitted and received via the communication I/F 241. The CPU 242 executes a control program stored in the memory 243 to perform various kinds of control for sheet discharge. The memory 243 stores the control program. Further, the memory 243 provides a work area where the CPU 242 executes various processes. The sheet discharge control unit 244 discharges the conveyed recording material, based on an instruction from the CPU 242.

### <External Controller>

The external controller 102 includes a LAN I/F 213, a LAN I/F 214, and a video I/F 215 to communicate with other devices. The external controller 102 includes a CPU 208, a memory 209, and a storage 210 to control operations of the external controller 102. The external controller 102 includes a keyboard 211 and a display 212 as user interfaces. These components are connected to each other via a system bus 216 to communicate with each other.

The LAN I/F 213 is connected to the client PC 103 via an outside LAN 104 and controls communication with the client PC 103. The external controller 102 acquires a print job from the client PC 103 via the LAN I/F 213. The LAN I/F 214 is connected to the printing apparatus 107 via the internal LAN 105 and controls communication with the printing apparatus 107. The external controller 102 transmits a print setting to the printing apparatus 107 via the LAN OF 214. The video OF 215 is connected to the printing apparatus 107 via the video cable 106 and controls communication with the printing apparatus 107. The external controller 102 transmits image data to the printing apparatus 107 via the video OF 215.

The CPU 208 executes a computer program stored in the storage 210 to comprehensively perform processing, such as receiving of image data transmitted from the client PC 103, raster image processor (RIP) processing, and transmitting of image data to the image forming apparatus 101. The memory 209 provides a work area where the CPU 208 executes various processes. The keyboard 211 is an input device that receives input of various settings and instructions of operations from the user. The display 212 is an output device that displays information of an application executed by the external controller 102 as a still image or a moving image.

### <Client PC>

The client PC 103 includes a CPU 201, a memory 202, a storage 203, a keyboard 204, a display 205, and a LAN OF 206. These components are connected to each other via a system bus 207 to be able to communicate with each other.

The CPU 201 executes a computer program stored in the storage 203 to control operations of the client PC 103. In the present exemplary embodiment, the CPU 201 performs an image data generation process and a print job transmission process. The memory 202 provides a work area where the CPU 201 executes various processes. The keyboard 204 and the display 205 are user interfaces. The keyboard 204 is an input device that receives an instruction from the user. The display 205 is an output device that displays information about an application executed by the client PC 103 as a still picture or a moving picture. The LAN OF 206 is connected to the external controller 102 via the external LAN 104 and controls communication with the external controller 102. The client PC 103 transmits a print job containing image data to the external controller 102 via the LAN OF 206.

While the external controller 102 and the image forming apparatus 101 are connected with each other via the internal LAN 105 and the video cable 106, the configuration is not limited to this as long as data transmission and reception for printing is able to be performed, which means that the external controller 102 and the image forming apparatus 101 may be connected with each other only via the video cable 106, for example. The memory 202, the memory 209, the memory 223, and the memory 243 may be any storage devices as long as the devices are for holding data or a program. Examples of the storage devices serving as the memories 202, 209, 223, and 243 include a volatile random access memory (RAM), a nonvolatile read only memory (ROM), a storage, and a universal serial bus (USB) memory.

### <Configuration of Image Forming Apparatus>

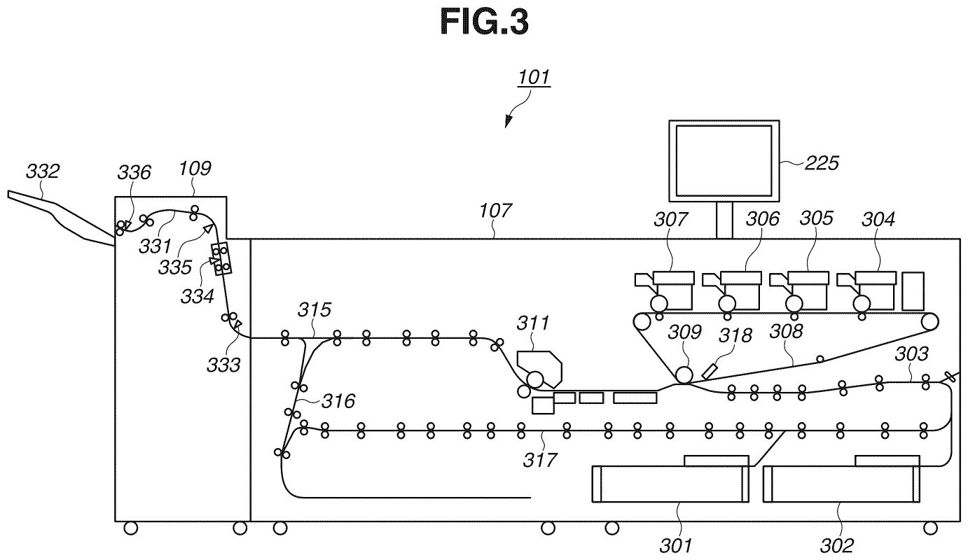

FIG. 3 is a schematic diagram illustrating a configuration of the image forming apparatus 101. The display 225 is disposed in an upper portion of the printing apparatus 107. The display 225 displays a printing status of the image forming apparatus 101 and information for a setting. A recording material (product) on which an image has been formed by the printing apparatus 107 is conveyed to the finisher 109 in a subsequent stage.

The printing apparatus 107 includes a plurality of sheet feeding decks 301 and 302 and a conveyance path 303 as the sheet feeding unit 230. Different types of recording materials are able to be accommodated in the sheet feeding decks 301 and 302. Information (grammage, recording material type, and the like) on the accommodated recording materials is able to be detected by the printing apparatus 107, and in the present exemplary embodiment, is able to be set by the user via the display 225.

The uppermost one of the recording materials accommodated in each of the sheet feeding decks 301 and 302 is separated and fed to the conveyance path 303. The printing apparatus 107 includes, as the exposure unit 227, image forming units 304, 305, 306, and 307 to form an image. The printing apparatus 107 forms a color image. In color image forming, the image forming unit 304 forms a black (K) image (toner image), the image forming unit 305 forms a cyan (C) image (toner image), the image forming unit 306 forms a magenta (M) image (toner image), and the image forming unit 307 forms a yellow (Y) image (toner image).

The printing apparatus 107 includes, as the image forming unit 228, the intermediate transfer belt 308 to which toner images are transferred from the image forming units 304, 305, 306, and 307, and a secondary transfer roller 309.

The intermediate transfer belt 308 rotates in the clockwise direction in FIG. 3, and toner images are transferred in a superimposed manner in the order of the image forming unit 307, the image forming unit 306, the image forming unit 305, and the image forming unit 304. In this way, a full-color toner image is formed on the intermediate transfer belt 308. The intermediate transfer belt 308 rotates to convey the toner image to a secondary transfer roller 309. The recording material is conveyed to the secondary transfer roller 309 in synchronization with a timing at which the toner image is conveyed to the secondary transfer roller 309. The secondary transfer roller 309 transfers the toner image on the intermediate transfer belt 308 to the conveyed recording material.

The printing apparatus 107 includes the fixing device 311. The fixing device 311 fixes the toner image on the recording material. For this purpose, the fixing device 311 includes a heating rotary member and a pressing rotary member. The recording material is applied with heat and pressure when passing through a nip portion N formed between the heating rotary member and the pressing rotary member. Thus, the toner image is melted and pressure-bonded to a first surface of the recording material.

The recording material that has passed through the fixing device 311 is guided to a conveyance path 315. In a case where an instruction for double-sided printing is issued, an image is also formed on the back surface (second surface). Thus, the recording material is guided to a reversing path 316. The conveyance direction of the recording material conveyed to the reversing path 316 is reversed in the reversing path 316, and the recording material is conveyed to a double-sided conveyance path 317. The recording material is reversed by switchback conveyance through the reversing path 316 and the double-sided conveyance path 317. The recording material is conveyed through the double-sided conveyance path 317 to the conveyance path 303 and passes the secondary transfer roller 309 and the fixing device 311, whereby an image is formed on the second surface different from the first surface.

In a case of single-sided printing or in a case where images have been formed on the both surfaces in double-sided printing, the recording material is conveyed to the conveyance path 315 and is delivered to the finisher 109.

The finisher 109 stacks recording materials delivered from the printing apparatus 107. The finisher 109 includes a conveyance path 331 and a stack tray 332 on which recording materials are stacked. Along the conveyance path 331, conveyance sensors 333, 334, 335, and 336 are disposed. Recording materials conveyed from the printing apparatus 107 is stacked on the stack tray 332 via the conveyance path 331. The conveyance sensors 333, 334, 335, and 336 detect passage of a recording material conveyed through the conveyance path 331. In a case where the conveyance sensors 333, 334, 335, and 336 do not detect a leading edge or a trailing edge of the recording material in the conveyance direction even after a predetermined time has elapsed from a conveyance start of the recording material, the CPU 242 determines that a conveyance jam (conveyance failure) has occurred in the finisher 109. In this case, the CPU 242 notifies the printing apparatus 107 that a conveyance jam has occurred.

### <Fixing Device>

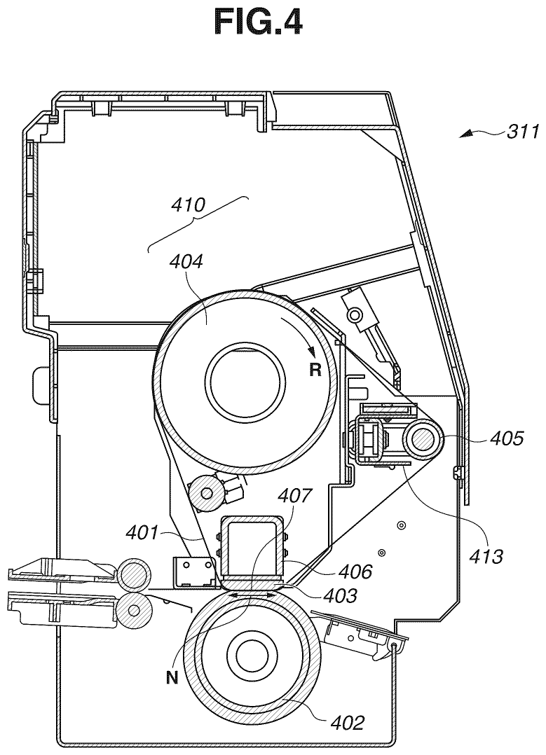

Next, referring to FIG. 4, a configuration of the fixing device 311 in the present exemplary embodiment will be described in detail. FIG. 4 is a cross-sectional view of the fixing device 311 in the present exemplary embodiment. In FIG. 4, the recording material is conveyed from the right to the left on the drawing. The fixing device 311 includes a heating unit 410 having a heat source, and a pressing rotary member (hereinafter referred to as a pressing roller) 402 forming the nip portion N together with the heating unit 410. The heating unit 410 includes a fixing belt (hereinafter, referred to as a belt) 401 as an endless rotatable heating rotary member, a pad member (hereinafter, referred to as a pad) 403 as a fixing member, a heating roller 404, and a steering roller 405.

The belt 401, having thermal conductivity, heat resistance, and the like, has a thin cylindrical shape. In the present exemplary embodiment, the belt 401 has a three layer structure in which a base layer, an elastic layer on the outer periphery of the base layer, and a releasing layer on the outer periphery of the elastic layer are formed. The base layer has a thickness of 60 micrometer (μm) and is made of polyimide resin (PI). The elastic layer has a thickness of 300 μm and is made of silicone rubber. The releasing layer has a thickness of 30 μm and is made of tetrafluoroethylene-perfluoro alkoxy ethylene copolymer resin (PFA) as a fluororesin. The belt 401 is stretched by the pad 403, the heating roller 404, and the steering roller 405.

The pad 403 is a member which is press-contacted to the pressing roller 402 via the belt 401 to form the nip portion N having a predetermined width with respect to the conveyance direction of the recording material. The pad 403 has a substantially rectangular cross section and has a length in the width direction of the belt 401. Because heat resistance is required to the material of the pad 403, a liquid crystal polymer (LCP) resin is used.

Between the pad 403 and the belt 401, a sliding sheet 407, a surface of which is coated with polytetrafluoroethylene (PTFE), is disposed and silicone oil S (hereinafter referred to as oil S) as a lubricant are applied, so that the belt 401 smoothly slides with respect to the pad 403.

The sliding sheet 407 has a PTFE coating formed on a surface of a polyimide base material having a thickness of 2 μm. The sliding sheet 407 is disposed to improve slidability between the pad 403 and the belt 401. The sliding sheet 407 may be replaced with a coating or the like that is applied on the surface layer of the pad 403 to improve slidability.

A stay 406 is disposed inside the belt 401. The stay 406 is disposed inside the pad 403 on a side opposite to a side with the sliding sheet 407. The stay 406 is a rigid reinforcing member which strengthens the pad 403 and has a length in the width direction of the belt 401. As the material of the stay 406, a drawn material of stainless steel (SUS) 304 having a thickness of 3 millimeters (mm) is used, and the strength is secured by a hollow form having a square cross section. In a case where the pad 403 is pressed against the stay 406 by the pressing roller 402, the stay 406 strengthens the pad 403 to ensure the pressing force at the nip portion N. The material of the stay 406 is not limited to stainless steel as long as the strength is able to be secured.

The heating roller 404 is a stainless steel pipe, having a thickness of 1 mm, in which a halogen heater (not illustrated) is disposed, and is able to generate heat up to a predetermined temperature. The belt 401 is heated by the heating roller 404, and the temperature is adjusted to a fixing temperature corresponding to a sheet type, based on a temperature detected by a thermistor. The temperature to be detected by the thermistor is not limited to the surface temperature of the heating roller 404, but may be the surface temperature of the belt 401. Further, the heating roller 404 may be configured to be rotationally driven. Rotational driving of the heating roller 404 increases the tension of the belt 401 from the nip portion N to the heating roller 404 in a belt rotation direction.

The increase in the tension of the belt 401 causes a curvature of the belt 401 at the exit of the nip portion N to be increased in the belt rotation direction, which results in improvement in the separation performance of a recording material. The fixing temperature in the present exemplary embodiment refers to the surface temperature of the heating roller 404. However, the present disclosure is not limited thereto. The fixing temperature may be the temperature of the heating roller 404 detected by the thermistor or the temperature of the belt 401.

The steering roller 405 suspends the belt 401 and is supported by a steering frame 413. Rotation of the steering frame 413 changes alignment of the steering roller 405 with respect to other suspension members. The alignment change leads to generation of a tension difference in the belt 401 between its portions before and after the steering roller 405, whereby the position of the belt 401 is controlled in the width direction of the belt 401. The steering roller 405 is urged with a spring supported by the steering frame 413 and also serves as a tension roller for applying a predetermined tension to the belt 401.

The pressing roller 402 has an elastic layer formed on the outer periphery of a shaft, and a releasing layer formed on the outer periphery of the elastic layer. The shaft is made of stainless steel, the elastic layer is made of conductive silicone rubber having a thickness of 5 mm, and the releasing layer is made of PFA as fluororesin having a thickness of 50 μm. The pressing roller 402 is axially supported by a frame of the fixing device 311. A gear is fixed to one end of the pressing roller 402, and the pressing roller 402 is connected to a driving source via the gear to be rotationally driven. The belt 401 rotates in a direction indicated by an arrow R while being held between the pressing roller 402 being rotated and the pad 403.

As described above, the pad 403, the heating roller 404, and the steering roller 405 are disposed along the inner peripheral surface of the belt 401 to suspend the belt 401. The belt 401 is held between the pressing roller 402 and the pad 403 and is rotated by rotation of the pressing roller 402. The belt 401 stores heat from the heating roller 404. When the recording material bearing an unfixed toner image is nipped and conveyed through the nip portion N by the pressing roller 402 and the belt 401, heat and pressure necessary to fix the toner image are applied to the recording material, whereby the toner image is fixed on the recording material.

<Relationship between Grammage and Conveyance Speed>

The image forming apparatus 101 in the present exemplary embodiment is able to convey the recording material at a plurality of speeds including a first speed and a second speed as a conveyance speed of the recording material passing the secondary transfer roller 309 and the fixing device 311. In the present exemplary embodiment, the first speed is a low speed of 400 millimeter per second (mm/s), and the second speed is a high speed of 600 mm/s. While the two speeds are used in the present exemplary embodiment as examples, the recording material may be conveyed at three or more speeds.

The image forming apparatus 101 in the present exemplary embodiment is able to form an image on a recording material having a large grammage and a recording material having a small grammage. Here, the recording material having a small grammage is defined as a recording material having a first grammage, and the recording material having a large grammage is defined as a recording material having a second grammage.

The reason why the recording material is conveyed at a plurality of speeds in the present exemplary embodiment will be described. As a grammage of a recording material increases, heat capacity of the recording material increases. As a grammage of a recording material increases, the amount of heat necessary to fix a toner image on the recording material increases. As the conveyance speed of the recording material increases, the time during which the recording material is heated in the nip portion N decreases. In view of the above described points, if the recording material having a large grammage is conveyed at the high speed, the fixability is not ensured in some cases. In order to ensure the fixability of the recording material having a large grammage, a low conveyance speed is provided in addition to the high conveyance speed. Further, in order to ensure high image quality, it is necessary to increase the time for application of heat at the nip portion N.

At the high speed of 600 mm/s (second speed), a certain image quality is able to be satisfied only with some recording materials, such as a recording material having the first grammage, which is small in grammage. With the low conveyance speed of 400 mm/s (first speed), it is possible to satisfy a certain image quality with respect to the recording material having the second grammage, which is a large grammage. That is, some of the above described recording materials are able to be conveyed at the first speed and the second speed. The recording material that is able to be conveyed at the first speed and the second speed is referred to as a first recording material. On the other hand, a recording material that is able to be conveyed at the first speed is referred to as a second recording material.

Further, the conveyance speed and the fixing temperature (set temperature) are changed for each recording material to realize a constant fixability and image quality. The image forming apparatus 101 is able to receive page information from the external controller 102 before sheet feeding. The page information contains information on a sheet feeding deck in which a recording material to be fed is stored, a size of the recording material, a type of the recording material (coated sheet, embossed sheet, or the like), a grammage of the recording material, and whether the recording material is the final page of the print job. The conveyance speed and the fixing temperature are determined based on the grammage. More specific details of the grammage, the conveyance speed, and the fixing temperature are determined based on an operation mode selected by the user. In the present exemplary embodiment, the conveyance speed and the fixing temperature are determined in accordance with a determined grammage. However, the conveyance speed and the fixing temperature may be determined by a different method. For example, the conveyance speed and the fixing speed may be determined in accordance with the recording material size and the recording material type. While, in the present exemplary embodiment, the high conveyance speed is 600 mm/s and the low conveyance speed is 400 mm/s, other speeds may be used. Further, three or more conveyance speeds may be provided.

The recording material having a small grammage is conveyed at the high speed and fixing is performed, and a recording material having a large grammage is conveyed at the low speed and fixing is performed. In a case where a job in which recording materials having a small grammage and a large grammage are mixed is executed, the conveyance speed is changed every time when a recording material having a different grammage is to be conveyed. This raises an issue that the number of sheets printable per unit time (productivity) decreases due to the changing time for changing the conveyance speed. Specifically, in a case of changing from the recording material having the small grammage to the recording material having the large grammage, in order to ensure the fixability, the recording material conveyance speed is to be changed from a high speed to a low speed. It takes about 30 seconds to change the conveyance speed. This results in occurrence of downtime during the changing time of the conveyance speed.

Thus, before a printing process is started, information on types of a predetermined number of recording materials to be printed is acquired, and a conveyance speed at which all the recording materials having different grammages are able to be conveyed is selected, to reduce the number of conveyance speed changing times, which prevents occurrence of the downtime.

### <Fixing Temperature Adjustment Mode>

The fixing device 311 in the present exemplary embodiment has a plurality of types of temperature adjustment modes. The reason why the plurality of types of temperature adjustment modes is provided is as follows. If recording materials having various grammages are fixed at the same temperature, it is not necessary to provide the plurality of types of temperature adjustment modes. However, if the recording materials having various grammages are fixed at the same temperature, there is a possibility that insufficient heat is applied or excessive heat is applied to the recording materials.

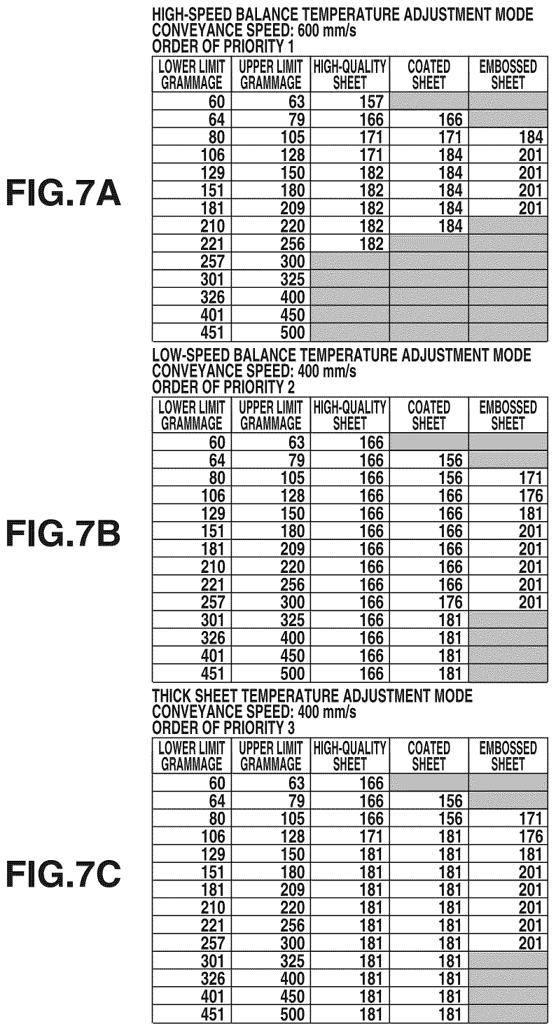

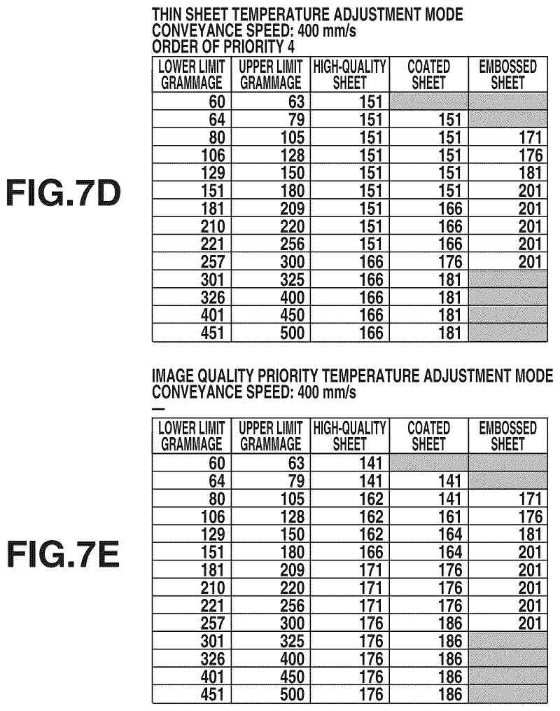

FIGS. 7A to 7E are temperature tables of temperature adjustment modes for the above described two types of conveyance speeds in the present exemplary embodiment. The temperature adjustment modes of the tables in FIGS. 7A to 7E are a high-speed balance temperature adjustment mode, a low-speed balance temperature adjustment mode, a thick sheet temperature adjustment mode, a thin sheet temperature adjustment mode, and an image quality priority temperature adjustment mode, respectively. The temperature adjustment modes each have temperatures set in accordance with grammages and types of the recording material.

The CPU 222 refers to the temperature table of the selected temperature adjustment mode, and the temperature of the heating roller 404 of the fixing device 311 is changed in accordance with a grammage and a type of a recording material to be subjected to fixing. The characteristics of the temperature tables will be described below. In FIGS. 7A to 7E, temperatures corresponding to grammages are described. As shown in FIGS. 7A to 7E, in the present exemplary embodiment, the same grammage has a predetermined range.

Further, the fixing device 311 in the present exemplary embodiment has a productivity priority mode in which productivity is prioritized and an image quality priority mode in which image quality is prioritized, and changing between the above described temperature adjustment modes is able to be performed based on these modes.

In the productivity priority mode, the mode changing is able to be performed between a plurality of types of temperature adjustment modes. The productivity priority mode includes the thick sheet temperature adjustment mode in which the productivity of thick sheets is prioritized, the thin sheet temperature adjustment mode in which the productivity of thin sheets is prioritized, and a balance temperature adjustment mode in which the productivity of sheets having a grammage between the grammage of thin sheets and the grammage of thick sheets is prioritized.

Further, as a mode in the productivity priority mode, there is provided a sheet type specific productivity priority mode in which the above described temperature adjustment mode is selected in accordance with a sheet type. With the plurality of types of temperature adjustment modes that is to be selectively set in accordance with a grammage of a recording material on which printing is to be performed, the productivity is increased. In a case of a job in which recording materials having 64 grams per square (gsm) and recording materials having 106 gsm defined as thin sheets are mixed, if the thin sheet temperature adjustment mode is used for fixing, the fixing is performed at the same temperature. However, if the thick sheet temperature adjustment mode is used for fixing, the temperature of the belt 401 is to be changed from 166 degrees Celsius (° C.) to 171° C. Thus, in the job in which the recording materials having 64 gsm and the recording materials having 106 gsm are mixed, the productivity of printing with fixing in the thin sheet temperature adjustment mode is higher than the productivity of printing with fixing in the thick sheet temperature adjustment mode. That is, in a case of a job in which recording materials having a predetermined grammage or less are mixed, the productivity of printing in which the thin sheet temperature adjustment mode is used for fixing is higher than the productivity of printing in which the thick sheet temperature adjustment mode is used for fixing. Similarly, in a case of a job in which recording materials having 221 gsm and recording materials having 257 gsm defined as thick sheets are mixed, if the thick sheet temperature adjustment mode is used for fixing, the fixing is performed at the same temperature. However, if the thin sheet temperature adjustment mode is used for fixing, the temperature of the belt 401 is to be changed from 151° C. to 166° C. Due to changing of the temperature of the belt 401 in this way, image forming is sometimes to be suspended. Thus, in the job in which the recording materials having 221 gsm and the recording materials having 257 gsm are mixed, the productivity of printing with fixing in the thick sheet temperature adjustment mode tends to be higher than the productivity of printing with fixing in the thin sheet temperature adjustment mode. That is, in a case where the recording materials having a predetermined grammage or more are mixed, the productivity of printing in which the thick sheet temperature adjustment mode is used for fixing tends to be higher than the productivity of printing in which the thin sheet temperature adjustment mode is used for fixing. As the specific example, recording materials having a grammage from 52 gsm to 105 gsm are defined as thin sheets, recording materials having a grammage from 106 gsm to 220 gsm are defined as normal sheets, and recording materials having a grammage from 221 gsm to 350 gsm are defined as thick sheets. In the present exemplary embodiment, in the thin sheet temperature adjustment mode, the same temperature is set for the grammages in the range of the thin sheets. Similarly, in the thick sheet temperature adjustment mode, the same temperature is set for the grammages in the range of the thick sheets, and in the balance temperature adjustment mode, the same temperature is set for the grammages in the range of the normal sheets. The grammage ranges in each of which fixing is able to be performed at the same temperature are varied among the temperature adjustment modes. With this configuration, the productivity is improved in accordance with a grammage.

In regard to embossed sheets, unless the temperature adjustment is set to an appropriate value, there is a possibility that a toner image on a recording material peels off. Therefore, in a case where the conveyance speed is 400 mm/s, the temperatures of the belt 401 with respect to grammages are the same in any temperature adjustment modes.

On the other hand, in a mixed job in which recording materials having various grammages are mixed, the temperature of the belt 401 is to be changed every time a recording material having a different grammage is to be conveyed. In order to address this issue, a mixed sheet productivity priority mode is provided as one of the productivity priority modes. In this mode, information on grammages of a predetermined number of recording materials is acquired in advance. Then, based on the acquired information, a mode in which the amount of temperature change is to be smallest is selected from among the thick sheet temperature adjustment mode, the thin sheet temperature adjustment mode, the thick sheet temperature adjustment mode, and the balance temperature adjustment mode, to prevent occurrence of the downtime due to the temperature change time.

The image forming apparatus 101 also has the image quality priority mode. The image quality priority mode is a mode to prioritize image quality of an image to be formed. Thus, the temperature is to be changed in accordance with grammages divided into ranges smaller than the ranges of the case in the productivity priority mode. Image quality of a toner image formed on a recording material varies with the amount of heat applied to the toner image. An appropriate temperature varies in accordance with a grammage of a recording material, and image quality is able to be improved by application of the appropriate temperature. In the image quality priority temperature adjustment mode which is selected in the image quality priority mode, temperatures are divided into smaller ranges on the basis of grammages and types (coated sheet or non-coated sheet) of recording materials. Thus, in a case where a mixed job in which recording materials having various grammages are mixed is printed in the image quality priority mode, the temperature of the belt 401 is changed more frequently than the case where the mixed job is printed in the productivity priority mode. In a case where the temperature of the belt 401 is changed, time for changing the temperature is to be taken. Consequently, the productivity tends to be lowered. Between the case where the mixed job is printed in the image quality priority mode and the case where the mixed job is printed in the productivity priority mode, the image quality tends to be higher in the case where the mixed job is printed in the image quality priority mode than the case where the mixed job is printed in the productivity priority mode. Further, in the case where printing is performed in the image quality priority mode, the productivity tends to be lower than the case where printing is performed in the productivity priority mode.

The image forming apparatus 101 in the present exemplary embodiment changes determination for changing the temperature adjustment mode and the conveyance speed between a first sheet and second and subsequent sheets in a mixed job in which recording materials having various grammages are mixed. With this configuration, the number of times of changing the fixing temperature of the recording material and the number of times of changing the conveyance speed are reduced, whereby a decrease in productivity can be suppressed. The details will be described below.

First, printing modes of the image forming apparatus 101 in the present exemplary embodiment will be described. The image forming apparatus 101 has a plurality of modes including the productivity priority mode and the image quality priority mode, and further, the productivity priority mode includes two modes of the mixed sheet productivity priority mode and the sheet type specific productivity priority mode.

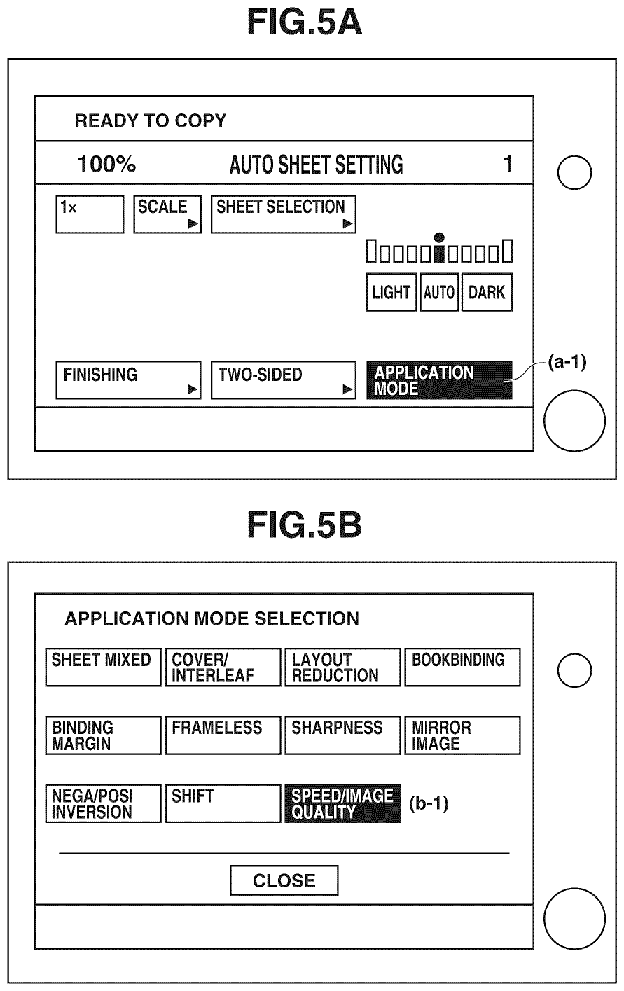

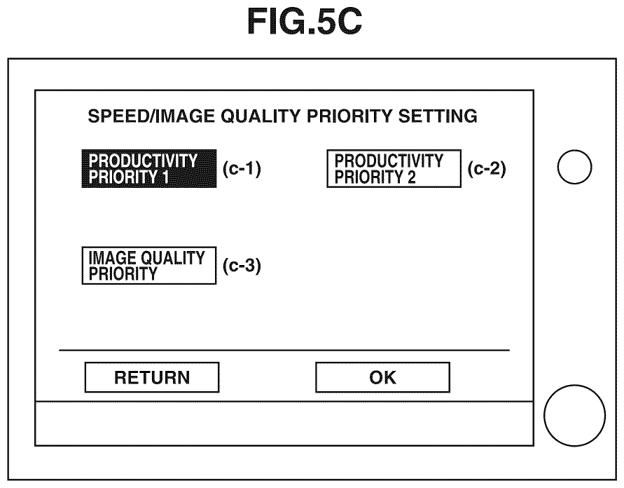

The user sets the above described printing mode (operation mode) via a setting screen on the display 225 displayed by the CPU 222. FIG. 5A illustrates an initial screen. In a case where the user selects a soft key (a-1) of APPLICATION MODE from the initial screen, an application mode selection screen illustrated in FIG. 5B is displayed on the display 225. In a case where the user selects a soft key (b-1) of SPEED/IMAGE QUALITY from the application mode selection screen, the CPU 222 displays a speed/image quality priority setting screen illustrated in FIG. 5C on the display 225.

In a case where the user selects a soft key (c-1) of PRODUCTIVITY PRIORITY 1 in FIG. 5C and presses an OK button, the image forming apparatus 101 operates in the mixed sheet productivity priority mode. Determination of which temperature adjustment mode is to be used and at which speed printing is to be performed in a case where the mixed sheet productivity priority mode is set will be described in temperature adjustment and speed changing control during printing to be described below.

In a case where the user selects a soft key (c-2) of PRODUCTIVITY PRIORITY 2 in FIG. 5C and presses the OK button, the image forming apparatus 101 operates in the sheet type specific productivity priority mode. In a case where the user selects a soft key (c-3) of IMAGE QUALITY PRIORITY MODE in FIG. 5C and presses the OK button, the image forming apparatus 101 operates in the image quality priority mode. As an initial value, PRODUCTIVITY PRIORITY 1 is selected.

### <Setting of Embossed Depth>

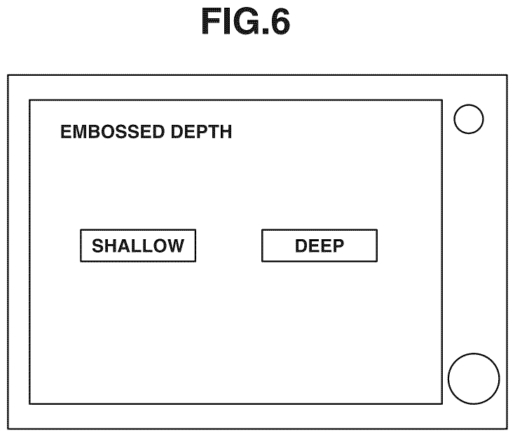

In a case of a recording material having an uneven surface and low smoothness, such as an embossed sheet, a transfer defect may occur when toner is transferred to the recording material at the secondary transfer portion. In the present exemplary embodiment, a mode for preventing the transfer defect is provided, and the user selects the mode for each sheet feeding deck via a setting screen displayed on the display 225. Among embossed sheets, there are many types of embossed depth, and in the present exemplary embodiment, one of two types of depth, deep and shallow, is settable to adapt to the types. The number is not limited to two, and may be two or more for the detailed setting. FIG. 6 is a screen on which a mode for embossed sheets to prevent the transfer defect is selected, and in a case where DEEP is selected, a mode (deep mode) to prevent the transfer defect is set. As an initial value, SHALLOW is selected (shallow mode).

In the present exemplary embodiment, the transfer defect is prevented by using the backup member 318 that lengthens the contact surface between the intermediate transfer belt 308 and a recording material. The displacement amount of the backup member 318 to cause the intermediate transfer belt 308 to be stretched outward in the vicinity of an entrance of the secondary transfer roller 309 is set to 3.4 mm in a case where the deep mode is selected and is set to 1.4 mm in a case where the shallow mode is selected.

Further, because the change in the length of the contact surface between the intermediate transfer belt 308 and a recording material leads to a change in the difference between the surface speeds, the driving speed of the secondary transfer roller 309 is set to −0.9% with respect to the conveyance speed in a case where the deep mode is selected, and is set to −1.5% in a case where the shallow mode is selected.

In a case where DEEP is selected for the embossed depth, the image quality priority temperature adjustment mode is used as a fixing temperature adjustment mode to improve the fixability.

### <Temperature Adjustment Mode and Speed Changing Control During Printing>

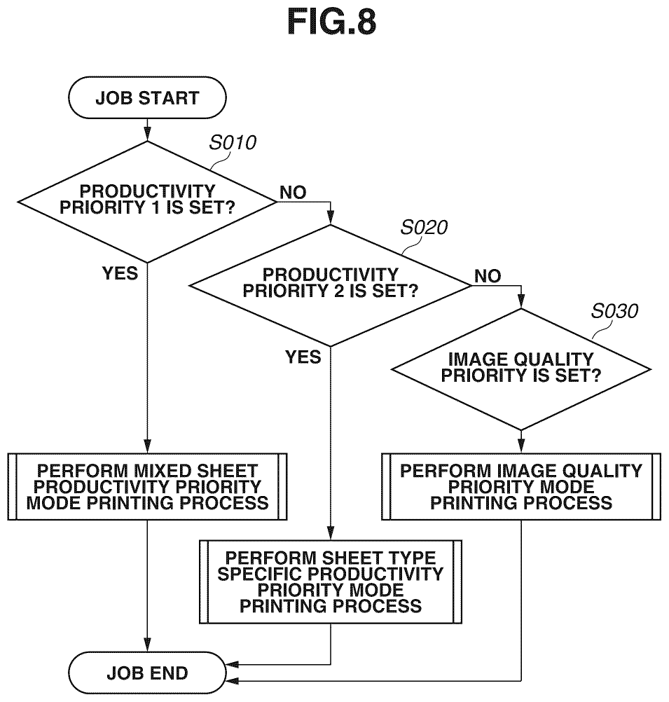

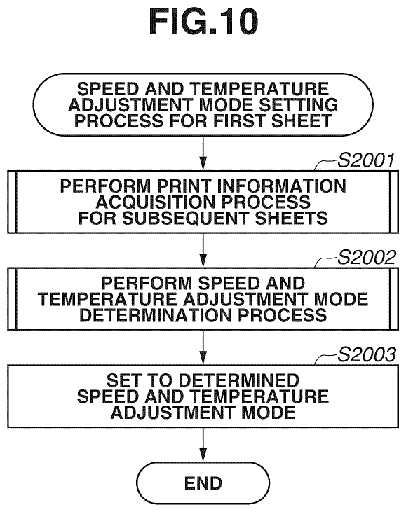

FIG. 8 is a flowchart illustrating the image forming process in the present exemplary embodiment. FIG. 10 is a flowchart illustrating a process in which print plan information about a plurality of sheets is acquired prior to a print job, and a temperature adjustment mode and a conveyance speed of the sheets are set based on the print plan information so that the time until completion of printing including temperature change time of the fixing device 311 and conveyance time is shortened.

The image forming process is started when the printing apparatus 107 receives a print job start instruction from the operation unit 224 or the client PC 103.

In step S010, in response to receipt of the print job start instruction, the CPU 222 determines in which print mode the print job is to be executed, based on the above described print mode setting. In a case where the user has selected PRODUCTIVITY PRIORITY 1 on the setting screen illustrated FIG. 5C (YES in step S010), the CPU 222 determines that the mixed sheet productivity priority mode is executed. The mixed sheet productivity priority mode is a mode in which information on recording materials for a plurality of pages is acquired before the print job is executed. In a case where the user has not selected the PRODUCTIVITY PRIORITY 1 on the setting screen illustrated in FIG. 5C (NO in step S010), the processing proceeds to step S020.

In step S020, in a case where the user has selected PRODUCTIVITY PRIORITY 2 on the setting screen of FIG. 5C (YES in step S020), the CPU 222 determines that the sheet type specific productivity priority mode is executed. The sheet type specific productivity priority mode is a mode in which the information on recording materials for a plurality of pages is not acquired before the print job is executed. In a case where the user has not selected PRODUCTIVITY PRIORITY 2 on the setting screen of FIG. 5C (NO in step S020), the processing proceeds to step S030.

In step S030, in a case where the user has selected IMAGE QUALITY PRIORITY on the setting screen of FIG. 5C (YES in step S030), the CPU 222 determines that the image quality priority mode is executed. The image quality priority mode is a mode in which the information on recording materials for a plurality of pages is not acquired before the print job is executed.

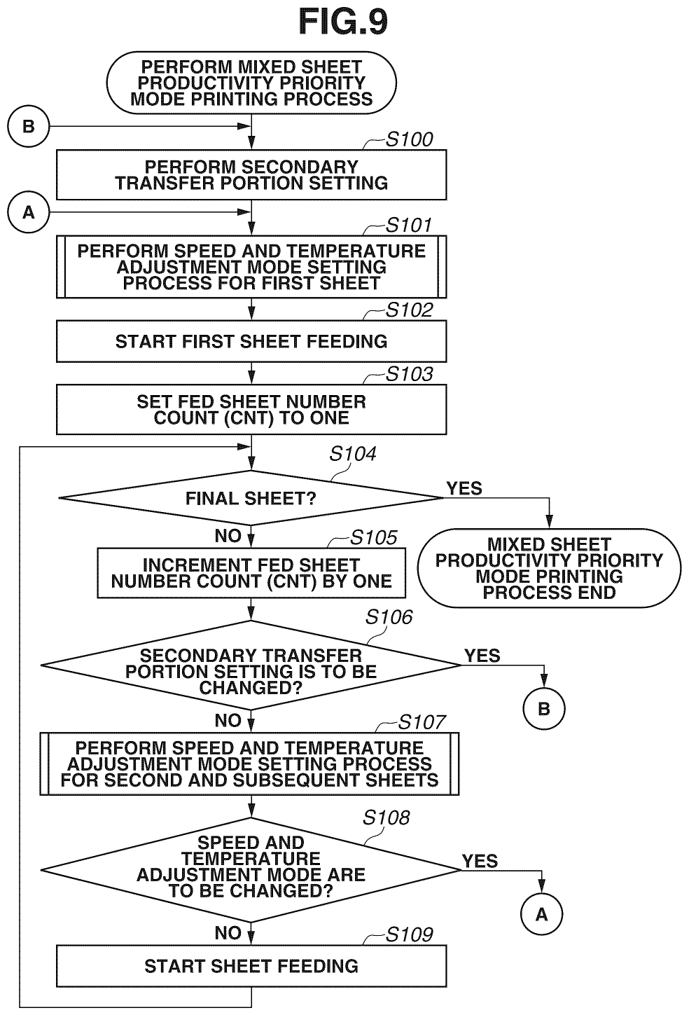

Next, the operation in the mixed sheet productivity priority mode will be described with reference to FIG. 9.

In step S100, in response to receipt of the print job start instruction, the CPU 222 performs a setting of the secondary transfer portion in accordance with the first sheet. In the setting of the secondary transfer portion, the CPU 222 sets the position of the backup member 318 and the speed of the secondary transfer roller 309 which are determined by selecting DEEP or SHALLOW in the setting of embossed depth described with reference to FIG. 6.

In step S101, the CPU 222 acquires information on a predetermined number of sheets of the recording materials by a speed and temperature adjustment mode setting process for the first sheet, and controls the temperature adjustment mode and the conveyance speed for the first sheet. The speed and temperature adjustment mode setting process for the first sheet will be described below with reference to FIG. 10.

In a case where the CPU 222 determines that the mixed sheet productivity priority mode is executed, the CPU 222 sets the acquisition number of pages for recording material information to be acquired by the acquisition unit 261 to 100 before the print job is started. In the present exemplary embodiment, the recording material information to be acquired by the acquisition unit 261 is about grammages of the recording materials.

In step S102, after the CPU 222 sets the conveyance speed and the temperature adjustment mode in the speed and temperature adjustment mode setting process for the first sheet, the CPU 222 starts sheet feeding and printing of the first sheet based on the setting of the conveyance speed and the temperature adjustment mode for the first sheet.

In step S103, a fed sheet number count CNT for counting the number of sheets fed from the sheet feeding unit 230 is set to 1.

In step S104, the CPU 222 determines whether the fed sheet is the final sheet.

In a case where the CPU 222 determines that the fed sheet is the final sheet (YES in step S104), the CPU 222 waits for completion of printing of the final sheet and ends the print job.

In step S104, in a case where the CPU 222 determines that the fed sheet is not the final sheet (NO in step S104), the processing proceeds to step S105. In step S105, the fed sheet number count CNT for counting the number of sheets fed from the sheet feeding unit 230 is incremented by 1.

In step S106, the CPU 222 determines whether the setting of the secondary transfer portion needs to be changed for the recording material to be fed next. In the present exemplary embodiment, in a case where the current setting of the embossed depth is different from the setting for the recording material to be fed next, the setting of the secondary transfer portion is to be changed. In a case where the CPU 222 determines that the setting of the secondary transfer portion is to be changed (YES in step S106), after printing of the recording material which has been fed is completed, the print job is suspended, and the processing returns to step S100 to change the setting of the secondary transfer portion. Then, in the speed and temperature adjustment mode setting process for the first sheet, the CPU 222 acquires recording material information on a predetermined number of sheets from among recording materials to be processed after the suspending, and determines the speed and the temperature adjustment mode. A speed changing process and a temperature adjustment mode changing process are executed as necessary depending on the speed and the temperature adjustment mode set before the suspending, and the suspended print job is resumed after the belt 401 reaches the temperature adjustment temperature of the determined temperature adjustment mode.

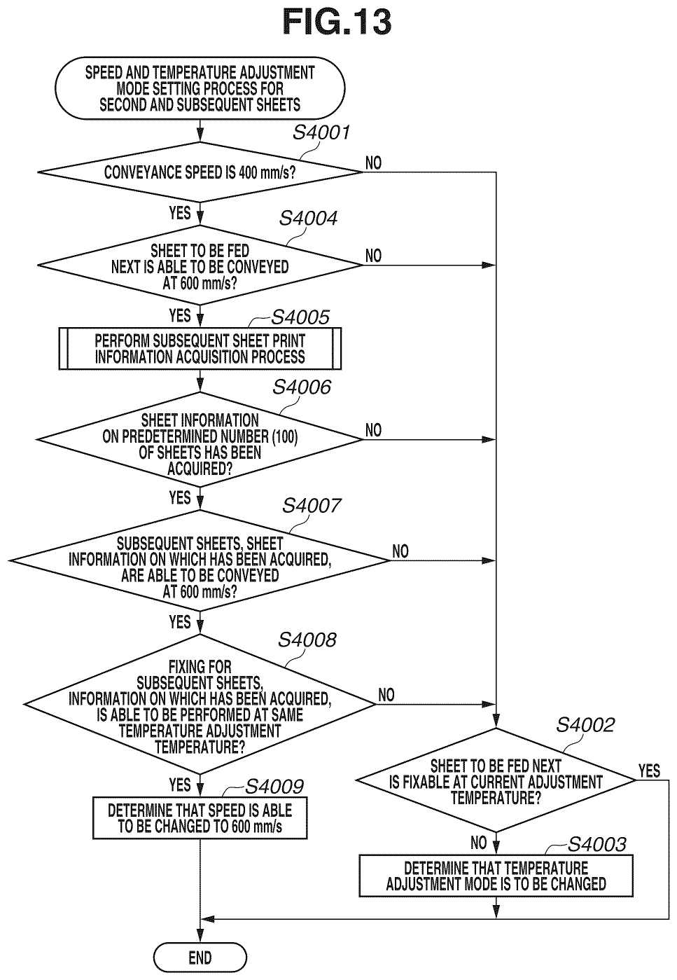

In step S106, in a case where the CPU 222 determines that the setting change of the secondary transfer portion is not to be performed (NO in step S106), the processing proceeds to step 107. In step S107, a speed and temperature adjustment mode setting process for the second and subsequent sheets is executed for the recording material to be fed next. The speed and temperature adjustment mode setting process for the second and subsequent sheets will be described below with reference to FIG. 13.

In step S108, based on the result of the speed and temperature adjustment mode setting process for the second and subsequent sheets in step S107, in a case where the CPU 222 determines that that the current conveyance speed and the current temperature adjustment mode are to be changed for the recording material to be fed (YES in step S108), the job is suspended after completion of printing of the recording material having being fed, and the process returns to step S101. In the speed and temperature adjustment mode setting process for the first sheet, the CPU 222 acquires recording material information on a predetermined number of sheets from among recording materials to be processed after the suspending, and determines the speed and the temperature adjustment mode. The speed changing process and the temperature adjustment mode changing process are executed as necessary depending on the speed and the temperature adjustment mode set before the suspending, and the suspended print job is resumed after the belt 401 reaches the temperature adjustment temperature of the determined temperature adjustment mode.

In a case where it is determined that the current conveyance speed and the current temperature adjustment mode are not to be changed for the recording material to be fed (NO in step S108), the processing proceeds to step S109. Then, in step S109, sheet feeding is started.

### <Speed and Temperature Adjustment Mode Setting Process for First Sheet>

The speed and temperature adjustment mode setting process for the first sheet in the present exemplary embodiment will be described with reference to FIG. 10.

In step S2001, the CPU 222 acquires print information on a predetermined number of sheets subsequent to the first sheet. A subsequent sheet print information acquisition process will be described below.

In step S2002, the CPU 222 uses the print information acquired in step S2001 to determine the temperature adjustment mode and the conveyance speed in a speed and temperature adjustment mode determination process.

The speed and temperature adjustment mode determination process will be described below.

In step S2003, the CPU 222 sets the temperature adjustment mode and the conveyance speed to the temperature adjustment mode and the conveyance speed determined in step S2002.

### <Subsequent Sheet Print Information Acquisition Process>

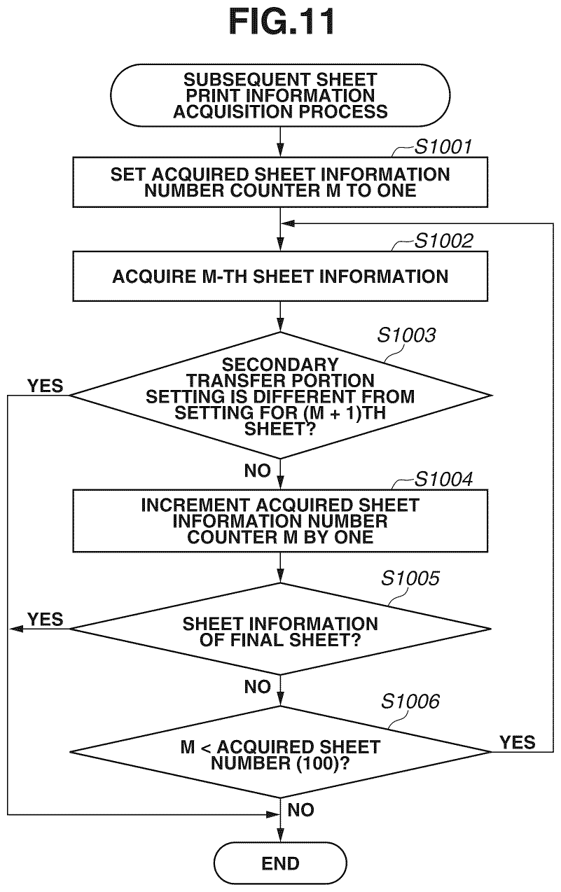

FIG. 11 is a flowchart of a process in which the CPU 222 causes the acquisition unit 261 to acquire print plan information (such as grammages of print recording materials) on a predetermined number of sheets, which is a maximum of 100 pages in the present exemplary embodiment, from the external controller 102.

In step S1001, the CPU 222 sets an acquired sheet information number counter M for counting the number of sheets, information on which has been acquired, to 1.

In step S1002, the acquisition unit 261 acquires sheet information for one sheet from the external controller 102.

The sheet information contains settings of the type, grammage, size, and embossed depth of the recording material to be printed.

The CPU 222 stores the sheet information acquired via the acquisition unit 261 in the memory 223.

In step S1003, the CPU 222 determines whether the setting of the secondary transfer portion is different between the Mth sheet and the (M+1)th sheet. The setting of the secondary transfer portion is the setting of DEEP or SHALLOW in the setting of the embossed depth described above with reference to FIG. 6. In a case where the CPU 222 determines that the setting of the secondary transfer portion is different between the Mth sheet and the (M+1)th sheet (YES in step S1003), this subroutine process ends.

In a case where the CPU 222 determines that the setting of the secondary transfer portion is the same between the Mth sheet and the (M+1)th sheet (NO in step S1003), the processing proceeds to step S1004. In step S1004, the acquired sheet information number counter M is incremented by 1.

In step S1005, the CPU 222 determines whether the sheet information stored in step S1002 is about the final sheet of the print job.

In a case where the CPU 222 determines that the sheet information is not about the final sheet (NO in step S1005), the processing proceeds to step S1006. In step S1006, the CPU 222 performs determination of whether acquisition of the sheet information is completed, by determining whether M is less than a predetermined number of sheets. In a case where M is less than the predetermined number of sheets (YES in step S1006), the CPU 222 determines that acquisition of the sheet information for the predetermined number of sheets has not been completed, the processing returns to S1002, and the CPU 222 acquires the acquired information on the next sheet. In a case where M is the predetermined number of sheets (NO in step S1006), the CPU 222 determines that the sheet is the final sheet, and this subroutine process ends. In the present exemplary embodiment, the predetermined number of sheets is 100.

By the above procedure, the CPU 222 acquires the print plan information for M sheets.

### <Speed and Temperature Adjustment Mode Determination Process>

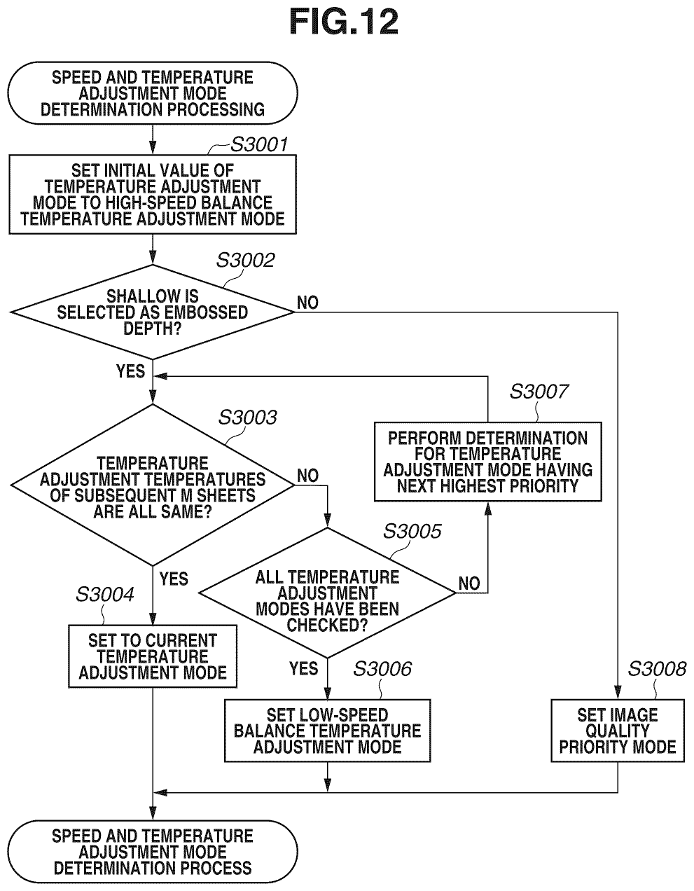

FIG. 12 is a flowchart illustrating processing that is performed by the CPU 222 to determine the conveyance speed and the temperature adjustment mode for fixing in accordance with the sheet information acquired for M sheets. In the mixed sheet productivity priority mode, the CPU 222 performs determination of whether all temperature adjustment temperatures corresponding to grammages in the acquired sheet information are the same, in descending order of priority from the high-speed balance temperature adjustment mode, the low-speed balance temperature adjustment mode, the thick sheet temperature adjustment mode, and the thin sheet temperature adjustment mode illustrated in 7A to 7E. In a case where all the temperature adjustment temperatures are the same, the mode is determined to the determined temperature adjustment mode, and at the same time, the conveyance speed is determined to the conveyance speed corresponding to the temperature adjustment mode.

In step S3001, the CPU 222 sets, as the initial temperature adjustment mode, the high-speed balance temperature adjustment mode having the highest priority as illustrated in FIG. 7A.

In step S3002, the CPU 222 determines whether SHALLOW is selected for the setting of the embossed depth of the recording material.

In a case where the CPU 222 determines that SHALLOW is selected for the setting of the embossed depth of the recording material (YES in step S3002), the processing proceeds to S3003. In step S3003, the CPU 222 determines, in the above described subsequent sheet print information acquisition process, whether all the temperature adjustment temperatures corresponding to grammages in the sheet information on M sheets of the acquired sheet information number counter M are the same temperature adjustment temperature. In FIG. 7A, the recording materials having grammages of 257 gsm or more of the high-quality sheet, the recording materials having grammages of 221 gsm or more of the coated sheet, and the recording materials having grammages of 210 gsm or more of the embossed sheet in the high-speed balance temperature adjustment mode are grayed out. This indicates that recording materials having a grammage larger than or equal to 257 gsm of high-quality sheet, recording materials having a grammage larger than or equal to 221 gsm of coated sheet, or recording materials having a grammage larger than or equal to 210 gsm of embossed sheet are not able to be conveyed at the high speed. This is because if recording materials having a large grammage is fed at the high speed, the fixability is not ensured. In such a case, in the determination of the temperature adjustment temperature, temperature adjustment temperatures corresponding to the grammages are not the same.

In a case where the CPU 222 determines that all the temperature adjustment temperatures are the same (YES in step S3003), the processing proceeds to step S3004. In step 3004, the temperature adjustment mode determined in step S3002 is set.

In a case where the CPU 222 determines that the temperature adjustment temperatures are not the same (NO in step S3003), the processing proceeds to step S3005. In step S3005, the CPU 222 determines whether the determination has been executed for all the temperature adjustment modes.

In a case where the CPU 222 determines that the determination has been executed for all the temperature adjustment modes (YES in step S3005), the processing proceeds to step S3006. In step S3006, the CPU 222 sets the low-speed balance temperature adjustment mode in which the temperature adjustment difference between grammages is the smallest and the speed of 400 mm/s at which all the recording materials is able to be conveyed.

In a case where there is a temperature adjustment mode for which the determination has not been performed (NO in step S3005), the processing proceeds to step S3007. In step S3007, the determination is performed for the temperature adjustment mode having the next highest priority, and the processing returns to step S3003 to perform the determination. As illustrated in FIGS. 7A to 7E, the priority order is as follows: the high-speed balance temperature adjustment mode; the low-speed balance temperature adjustment mode; the thick sheet temperature adjustment mode; and the thin sheet temperature adjustment mode.

In step S3002, in a case where the CPU 222 determines that DEEP is selected in the setting of the embossed depth of the recording material (NO in step S3002), the processing proceeds to step S3008. In step S3008, the temperature adjustment mode is set to the image quality priority temperature adjustment mode.

In the speed and temperature adjustment mode determination process, in a case where there is a recording material that is not able to be conveyed at the high speed among the M sheets, a temperature adjustment mode for the low speed in which the sheet conveyance is performed at the low speed is selected. This is because, in a case where recording materials capable of being conveyed at both the high speed and the low speed and recording materials capable of being conveyed at the high speed are mixed, the conveyance speed is changed every time when a recording material having a different grammage is to be conveyed, and the changing frequency increases, which decreases the number of sheets printable per unit time. Thus, the conveyance speed is set to the low speed to reduce the conveyance speed changing frequency.

Further, the temperature adjustment mode in which all the M sheets are able to be fixed at the same temperature adjustment temperature is selected. This is because, in a case where the recording materials, the temperature adjustment temperatures of which are different, are mixed, the temperature adjustment temperature is changed every time when a recording material, the temperature adjustment temperature of which is different, is to be conveyed, which decreases the number of sheets printable per unit time. Thus, the temperature adjustment mode in which all the M sheets are able to be fixed at the same temperature adjustment temperature is selected to reduce the frequency of the temperature adjustment temperature change.

As described above, the temperature adjustment mode and the conveyance speed are determined in such a manner that the temperature adjustment temperature change and the conveyance speed change are not to be performed between the sheets, the sheet information of which has been determined.

As described above, the control unit 262 sets the conveyance speed and the temperature adjustment mode based on the sheet information on the recording materials acquired by the acquisition unit 261, whereby the CPU 222 determines the temperature adjustment mode and the conveyance speed of the first sheet.

<Speed and Temperature Adjustment Mode Setting Process for Second and Subsequent Sheets>

FIG. 13 is a flowchart illustrating the speed and temperature adjustment mode setting process for the second and subsequent sheets.

In step S4001, the CPU 222 determines whether the current conveyance speed is the low speed of 400 mm/s.

In a case where the CPU 222 determines that the current conveyance speed is not the low speed of 400 mm/s, i.e., conveyed at the high speed of 600 mm/s (NO in step S4001), the processing proceeds to step S4002.

In step S4002, the CPU 222 determines whether fixing for a sheet to be fed next is able to be performed at the temperature adjustment temperature of the current temperature adjustment mode. The temperature adjustment temperature is determined in accordance with the temperature adjustment mode and the grammage as shown in FIGS. 7A to 7E.

In a case where the CPU 222 determines that fixing for the sheet to be fed next is not able to be performed at the temperature adjustment temperature of the current temperature adjustment mode (NO in step S4002), the processing proceeds to step S4003. In step S4003, the CPU 222 determines that the temperature adjustment mode is to be changed.

In a case where the CPU 222 determines that the sheet is currently conveyed at the low speed of 400 mm/s (YES in step S4001), the processing proceeds to step S4004. In step S4004, the CPU 222 determines whether the sheet to be fed next is able to be conveyed at the high speed of 600 mm/s.

In a case where the sheet to be fed next is able to be conveyed at the high speed of 600 mm/s (YES in step S4004), the processing proceeds to step S4005. In step S4005, the CPU 222 acquires sheet information of the subsequent sheets by performing the subsequent sheet print information acquisition process.

In step S4006, the CPU 222 determines whether sheet information on 100 sheets of the subsequent sheets has been acquired. In a case where the acquired sheet information of the subsequent sheets is not on 100 sheets (NO in step S4006), the CPU 222 determines that the number of sheets to be printed until the end of the print job is less than 100, and the CPU 222 determines not to change the conveyance speed, and the processing proceeds to step S4002. In step S4002, the CPU 222 determines whether fixing for the sheet to be fed next is able to be performed at the temperature adjustment temperature of the current temperature adjustment mode.

In a case where the CPU 222 determines that the sheet information on 100 sheets of the subsequent sheets is acquired (YES in step S4006), the processing proceeds to step S4007. In step S4007, the CPU 222 determines whether all the predetermined number of subsequent sheets, sheet information on which has been acquired, are able to be conveyed at 600 mm/s. In a case where the CPU 222 determines that all the predetermined number of subsequent sheets, the sheet information on which has been acquired, are not able to be conveyed at 600 mm/s (NO in step S4007), the processing proceeds to step S4002. In step S4002, the CPU 222 determines whether fixing for the sheet to be fed next is able to be performed at the temperature adjustment temperature of the current temperature adjustment mode.

In a case where the CPU 222 determines that all the predetermined number of subsequent sheets are able to be conveyed at 600 mm/s (YES in step S4007), the processing proceeds to step S4008. In step S4008, the CPU 222 determines whether fixing for the predetermined number of subsequent sheets, the sheet information on which has been acquired, are able to be performed at the same temperature adjustment temperature, i.e., in the high-speed temperature adjustment mode (in the present exemplary embodiment, the high-speed balance temperature adjustment mode). In a case where the CPU 222 determines that fixing is not able to be performed at the same temperature adjustment temperature (NO in step S4008), the processing proceeds to step S4002. In step S4002, the CPU 222 determines whether fixing for the sheet to be fed next is able to be performed at the temperature adjustment temperature of the current temperature adjustment mode.

In a case where the CPU 222 determines that fixing for the predetermined number of subsequent sheets, the sheet information on which has been acquired, is able to be performed at the same temperature adjustment temperature, i.e., in the high-speed temperature adjustment mode (in the present exemplary embodiment, the high-speed balance temperature adjustment mode) (YES in step S4008), the processing proceeds to step S4009. In step S4009, the CPU 222 determines that the conveyance speed is able to be changed to the high speed.

By the above described procedure, the CPU 222 is able to determine the temperature adjustment mode and the conveyance speed of the sheet to be fed next in printing the second and subsequent sheets.

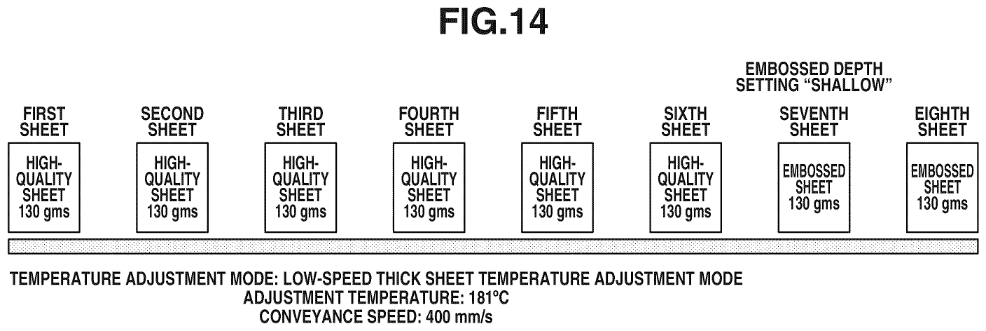

FIG. 14 illustrates an operation in the present exemplary embodiment of a case in which the first to sixth sheets are high-quality sheet having a grammage of 130 gsm, the seventh and eighth sheets are embossed sheet having a grammage of 130 gsm, and the embossed depth is set to SHALLOW. In accordance with the tables, illustrated in FIGS. 7A to 7E, indicating the relationships between grammages, conveyance speeds, and fixing speeds, in a case where the thick sheet temperature adjustment mode is selected, the high-quality sheet having a grammage of 130 gsm and the embossed sheet having a grammage of 130 gsm are able to be conveyed without changing of the conveyance speed and the temperature adjustment mode.

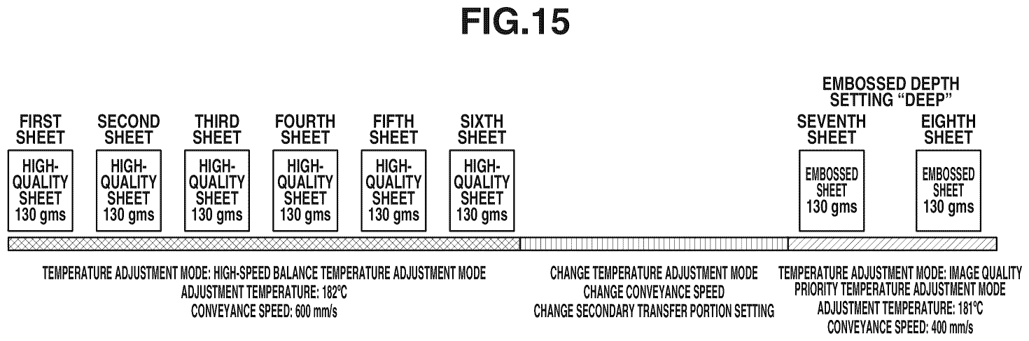

With reference to FIG. 15, a description will be given of an operation of a case where the sheet type and the grammage are the same as those of the print job illustrated in FIG. 14, and the embossed depth is set to DEEP for the seventh and eighth sheets. In a case where the embossed depth is set to DEEP, the setting of the secondary transfer portion is different between the sixth sheet, which is a high-quality sheet, and the seventh sheet, which is an embossed sheet, and time is consumed for the setting change. Thus, the temperature adjustment mode up to the sheet before occurrence of the setting change time is determined. In a case of the job illustrated in FIG. 15, the temperature adjustment mode is determined based on the recording material information on the first to sixth sheets. Since the first to sixth sheets have the same sheet type and grammage, the high-speed balance temperature adjustment mode is selected as the temperature adjustment mode, the temperature adjustment temperature is set to 182° C., and the conveyance speed is set to 600 mm/s. The temperature adjustment mode for the seventh and eighth sheets is the image quality priority temperature adjustment mode, and the temperature adjustment temperature is set to 181° C., and the conveyance speed is set to 400 mm/s. The temperature adjustment temperature and the conveyance speed are different between the sixth sheet and the seventh sheet, and the setting change time is consumed. However, since the setting change is performed simultaneously with the setting change of the secondary transfer portion, lowering of the productivity is prevented in the output time from the first sheet to the eighth sheet.

As described above, in the present exemplary embodiment, in printing in which the recording materials having different grammages and having different settings of the secondary transfer portion are mixed, a temperature adjustment mode is selected based on the recording material information on a recording material followed by a recording material having a different setting of the secondary transfer portion, whereby lowering of the productivity is prevented.

In a case where the image forming apparatus 101 suspends image formation for some reasons (for example, at the time of occurrence of a jam) and then resumes the image formation, the acquisition unit 261 performs the speed and temperature adjustment mode setting process for the first sheet. This configuration allows the image forming apparatus 101 to perform the image formation after the suspending without referring to information on the recording material conveyed before the suspending. For example, in a case where the conveyance speed before the suspending is the low speed, and grammages of recording materials to be conveyed after the suspending is only the first grammage, the conveyance speed after the suspending is able to be set to the second speed. As a result, the productivity after the suspending is able to be improved.

While, in the present exemplary embodiment, the number of sheets for determination of the temperature adjustment mode is determined in accordance with the setting of the embossed depth set by the user via the UI, in a case where the setting of the secondary transfer portion is changed in accordance with a sheet type and a grammage of the recording material, the temperature adjustment mode may also be determined by sheet information on a recording material to be conveyed before the setting of the secondary transfer portion is changed.

Further, not limited to the setting of the secondary transfer portion, in a case where change time occurs due to a factor other than the change for the temperature adjustment, the temperature adjustment mode may also be determined based on sheet information of a recording material to be conveyed before the change time occurs. For example, in a case where a print job is interrupted with a density adjustment in which a density detection pattern is formed on a recording material and the density is detected, it is desirable that the density detection be performed at a predetermined conveyance speed and a predetermined temperature adjustment temperature. Thus, the temperature adjustment mode may be determined based on sheet information on a recording material conveyed before the interruption, to perform the density adjustment. As another example, even in a case where an adjustment which consumes time is executed at an interval of recording materials during conveyance of recording materials, such as an adjustment to uniform the surface property of the fixing device or control for cleaning the charging wire, the temperature adjustment mode may also be determined based on the sheet information on a recording material conveyed before the adjustment.

Further, in the present exemplary embodiment, the change between the two speeds of 400 mm/s (first speed) and 600 mm/s (second speed) is performed for a predetermined recording material based on the print information. However, the speed may be changed as necessary, and three or more speeds may be used.

Further, in the present exemplary embodiment, in the mixed sheet productivity priority mode, the fixing temperature is determined to be one, but may be selectable from a predetermined range of temperature. Then, the information may be acquired through the print plan information acquisition, and the appropriate temperature setting may be selected.

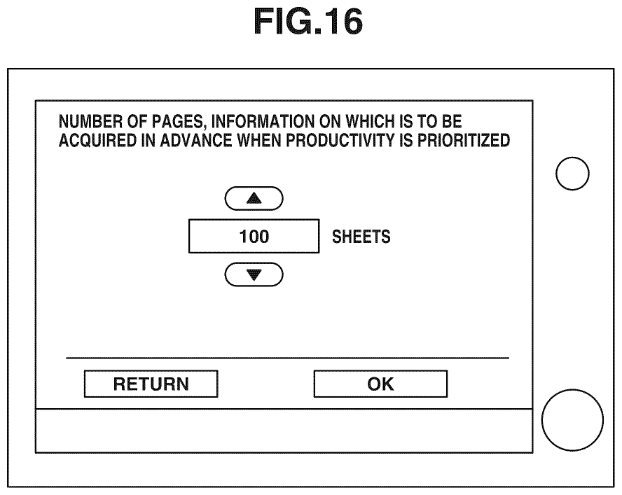

While, in the present exemplary embodiment, the print plan information is acquired for 100 sheets and the determination is performed, the number of sheets may be a different value, such as 120, or may be configured to be changeable to any value. For example, a setting screen as shown in FIG. 16 may be displayed to allow the user to perform the setting in accordance with a print job to be executed. In addition, the determination may be performed using data on a different number of sheets based on a condition, for example, using currently acquired sheet information.

Further, in the present exemplary embodiment, the temperature adjustment mode and the conveyance speed are determined using grammages contained in the print plan information. However, the temperature adjustment mode and the conveyance speed may be determined using information on a recording material size and a recording material type.

In the speed and temperature adjustment mode determination process, a printing speed may be checked with calculation to determine which mode results in the shortest printing time. For example, while the processing is performed on the precondition that printing 100 sheets at 400 mm/s is faster than printing 100 sheets with the speed being changed between 600 mm/s and 400 mm/s, in a case where the printing speed is obtained by calculation, a method of calculating the changing time may be used at the time of checking the printing speed. Thus, in a case where it is determined that printing with change in the conveyance speed results in a shorter printing time, the printing is performed with change in the conveyance speed.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described Embodiments and/or that includes one or more circuits (e.g., application specific integrated circuit (ASIC)) for performing the functions of one or more of the above-described Embodiments, and by a method performed by the computer of the system or apparatus by, for example, reading out and executing the computer executable instructions from the storage medium to perform the functions of one or more of the above-described Embodiments and/or controlling the one or more circuits to perform the functions of one or more of the above-described Embodiments. The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-180454, filed Nov. 10, 2022, which is hereby incorporated by reference herein in its entirety.

What is claimed is:

1. An image forming apparatus comprising:
a heating rotary member configured to apply heat to a recording material;
a pressing rotary member configured to be in contact with the heating rotary member to form a nip portion and, together with the heating rotary member, the pressing rotary member is configured to fix a toner image formed on the recording material;
an acquisition unit configured to acquire information about the recording material before image formation is started; and
a speed control unit configured to control a conveyance speed of the recording material at the nip portion, based on the information acquired by the acquisition unit,
wherein, in a print job in which a first recording material is a first sheet and the first recording material is a second sheet, the acquisition unit acquires information on the recording materials of the first sheet and the second sheet, and the speed control unit controls a conveyance speed of the recording material of the first sheet, based on the information on the first sheet and the second sheet, and
wherein, in a print job in which the first recording material is the first sheet and a second recording material is a third sheet, the acquisition unit acquires information on the first sheet and the third sheet, and the speed control unit controls the conveyance speed of the recording material of the first sheet, based on the information on the first sheet contained in the information on the first sheet and the third sheet.

2. The image forming apparatus according to claim 1,
wherein the speed control unit performs control to set the conveyance speed of the recording material at the nip portion to a first speed and a second speed faster than the first speed,
wherein, in the print job in which the first recording material is the first sheet and the first recording material is the second sheet, the first sheet and the second sheet are conveyed at the second speed, and
wherein, in the print job in which the first recording material is the first sheet and the second recording material is the third sheet, the first sheet is conveyed at the second speed and the third sheet is conveyed at the first speed.

3. The image forming apparatus according to claim 2, wherein the third recording material is an embossed sheet.

4. The image forming apparatus according to claim 3, further comprising a setting unit configured to perform a setting of an embossed depth with respect to the embossed sheet.

5. The image forming apparatus according to claim 2, wherein a grammage of the first recording material and a grammage of the third recording material are the same with each other, and, in a case where the fixing is performed on the first recording material and the third recording material at the first speed, a temperature of the fixing for the third recording material is higher than a temperature of the fixing for the first recording material.
